(19) United States
(12) Patent Application Publication
(10) Pub. No.: US 2007/0298864 A1
(43) Pub. Date: Dec. 27, 2007

(54) GAMING MACHINE AND GAMING METHOD THEREOF

(75) Inventor: Toshihiko KOSAKA, Tokyo (JP)

Correspondence Address: BANNER & WITCOFF, LTD., 1100 13th STREET, N.W., SUITE 1200, WASHINGTON, DC, 20005-4051, US

(73) Assignee: ARUZE CORP., Tokyo (JP)

(21) Appl. No.: 11/767,950

(22) Filed: Jun. 25, 2007

(30) Foreign Application Priority Data
Jun. 23, 2006 (JP) 2006-173521

(51) Int. Cl. G07F 17/00

(52) U.S. Cl. 463/20

(57) ABSTRACT

A gaming environment without reels is described. When a game is started in response to a bet being operated, symbols to be displayed on symbol display areas of symbol display portion are determined based on random number values and symbol lottery table. The determined symbols may be displayed on the symbol display areas at once.

### CROSS-REFERENCE TO RELATED APPLICATIONS

This application is based upon and claims a priority from the prior Japanese Patent Application No. 2006-173521 filed on Jun. 23, 2006, the entire contents of which are incorporated herein by reference.

### BACKGROUND

1. Field

One or more aspects of the present invention relate to a gaming machine and a gaming method thereof that control a game and provide an award to a player based on a combination of displayed symbols, in which the symbols are displayed on a display without mechanical reels.

2. Description of Related Art

Conventionally, in gaming machines, a game is started when gaming medium such as coin or token is input to the gaming machine, and symbol rows are variably displayed on predetermined areas of the gaming machines, and the symbol rows stopped when a predetermined time is elapsed, and a predetermined gaming medium corresponding to stopped symbols are provided to a player. The two main types of the device, that variably displays the symbol rows, are mechanical reels (real reels) and virtual reels (video reels). For example, with respect to the slot machines, fifteen symbols, which form a 5 (wild)×3 (height) rectangular grid, are displayed with the use of the video reels. With respect to the slot machines, when the game is started, mechanical reels are started to spin, and each three symbols corresponding to each symbol row are stopped when predetermined time is elapsed in accordance with the stop of the reels. And then, the award corresponding to the number of same stopped and displayed symbols or the combination of stopped and displayed symbols on paylines are provided to the player.

In the example of the slot machines, the symbols are variably displayed and stopped with the reel spinning. Accordingly, because of the nature of the reels, symbol rows are moved to one direction and variably displayed, and predetermined symbols among moving symbols are stopped and displayed. Here, alignment sequence of symbols on the reel is fixed.

### SUMMARY

In view of the foregoing, one or more aspects of the present invention relate to gaming machine, method of operating a game, computer readable medium having computer-executable instructions or the like that displays symbols without mechanical reel. Also, in one or more aspects, all symbols are displayed at once. In accordance with some aspects of the present invention, the symbols are displayed in random order. In accordance with some aspects of the present invention, the symbols are displayed in a predetermined order. One or more of the above aspects of the invention will be more fully described in the following detailed description when read in connection with the accompanying drawings. It is to be expressly understood, however, that the drawings are for purpose of illustration only and not intended as a definition of the limits of the invention.

### BRIEF DESCRIPTION OF THE DRAWINGS

The accompanying drawings, which are incorporated in and constitute a part of this specification illustrate embodiments of the invention and, together with the description, serve to explain the objects, advantages and principles of the invention.

FIG. 1 is a perspective view showing a slot machine in a first illustrative embodiment in accordance with one or more aspects of the present invention.

FIG. 2 is a view showing a symbol display portion in the first illustrative embodiment in accordance with one or more aspects of the present invention.

FIG. 3 is a view showing symbols displayed on the symbol display portion in accordance with one or more aspects of the present invention.

FIG. 4 is a view showing a payout table which indicates payout numbers to be provided to a player based on the symbol displayed in the symbol display portion in accordance with one or more aspects of the present invention.

FIG. 5 is an explanatory view showing a relation between combinations of symbols and payout numbers in accordance with one or more aspects of the present invention.

FIG. 6 is an explanatory view showing a an example in which displayed symbols are erased in accordance with one or more aspects of the present invention.

FIG. 7 is a block diagram schematically showing a control system of the slot machine in the first illustrative embodiment in accordance with one or more aspects of the present invention.

FIG. 8 is a view showing a symbol lottery table used when symbols to be displayed on the symbol display portion is determined by lottery.

FIG. 9 is a flowchart of a main control process program of the slot machine in the first illustrative embodiment in accordance with one or more aspects of the present invention.

FIG. 10 is a flowchart of a main game process program of the slot machine in the first illustrative embodiment in accordance with one or more aspects of the present invention.

FIG. 11 is an explanatory view showing an example in which payout information is displayed in a payout display process (S16) in the first illustrative embodiment in accordance with one or more aspects of the present invention.

FIG. 12 is an explanatory view showing an example in which payout information is displayed in a payout display process (S16) in the first illustrative embodiment in accordance with one or more aspects of the present invention.

FIG. 13 is an explanatory view showing an example in which payout information is displayed in a payout display process (S16) in the first illustrative embodiment in accordance with one or more aspects of the present invention.

FIG. 14 is a view showing a symbol display portion in case where displayed symbols are erased in accordance with one or more aspects of the present invention.

FIG. 15 is a flowchart of a main game process program of the slot machine in the second illustrative embodiment in accordance with one or more aspects of the present invention.

FIG. 16 is a view showing an example in which the symbols are displayed in a random order in the second illustrative embodiment in accordance with one or more aspects of the present invention.

FIG. 17 is a view showing an example in which the symbols are displayed in the random order in the second illustrative embodiment in accordance with one or more aspects of the present invention.

FIG. 18 is a view showing an example in which the symbols are displayed in the random order in the second illustrative embodiment in accordance with one or more aspects of the present invention.

FIG. 19 is a view showing an example in which the symbols are displayed in a regular order in the third illustrative embodiment in accordance with one or more aspects of the present invention.

FIG. 20 is a view showing an example in which the symbols are displayed in the regular order in the third illustrative embodiment in accordance with one or more aspects of the present invention.

FIG. 21 is a view showing an example in which the symbols are displayed in the regular order in the third illustrative embodiment in accordance with one or more aspects of the present invention.

FIG. 22 is a view showing an example in which the symbols are displayed in the regular order in the third illustrative embodiment in accordance with one or more aspects of the present invention.

### DETAILED DESCRIPTION

The various aspects summarized previously may be embodied in various forms. The following description shows by way of illustration of various combinations and configurations in which the aspects may be practiced. It is understood that the described aspects and/or embodiments are merely examples, and that other aspects and/or embodiments may be utilized and structural and functional modifications may be made, without departing from the scope of the present disclosure.

It is noted that various connections are set forth between items in the following description. It is noted that these connections in general and, unless specified otherwise, may be direct or indirect and that this specification is not intended to be limiting in this respect.

A gaming machine according to one or more aspects of the invention will be described in detail with reference to the drawings based on an embodiment embodying one or more aspects of the invention as a slot machine. However, it is appreciated that one or more aspects of the present invention may be embodied in distributable (via CD and the like) or downloadable software games, console games, and the like. In this regard, the slot machine may be a virtual slot machine that is displayed on a multi-purpose computer and/or dedicated kiosk. Aspects of the invention are described by way of hardware elements. However, it is appreciated that these elements may also be software modules that are executable in a computer. The software modules may be stored on a computer readable medium, including but not limited to a USB drive, CD, DVD, computer-readable memory, tape, diskette, floppy disk, and the like. For instance, aspects of the invention may be embodied in a JAVA-based application or the like that runs in a processor or processors. Further, the terms “CPU” and “processor” are inclusive by nature, including at least one of hardware, software, or firmware. These terms may include a portion of a processing unit in a computer (for instance, in multiple core processing units), multiple cores, a functional processor (as running virtually on at least one of processor or server, which may be local or remote). Further, in network-based gaming systems, the processor may include only a local processor, only a remote server, or a combination of a local processor and a remote server.

It is contemplated that one or more aspects of the invention may be implemented as computer executable instructions on a computer readable medium such as a non-volatile memory, a magnetic or optical disc. Further, one or more aspects of the invention may be implemented with a carrier signal in the form of, for instance, an audio-frequency, radio-frequency, or optical carrier wave.

Some embodiments (a first embodiment to a third embodiment, for instance) embodying one or more aspects of the invention as a slot machine will be described with reference to the drawings below. Here, in the slot machines of the first embodiment to the third embodiment, the slot machines are so-called video slot machines that have a display such as liquid crystal display in which various symbols are displayed thereon. Specifically, in one or more aspect of the invention, the symbols are variably displayed without mechanical reels.

### First Embodiment

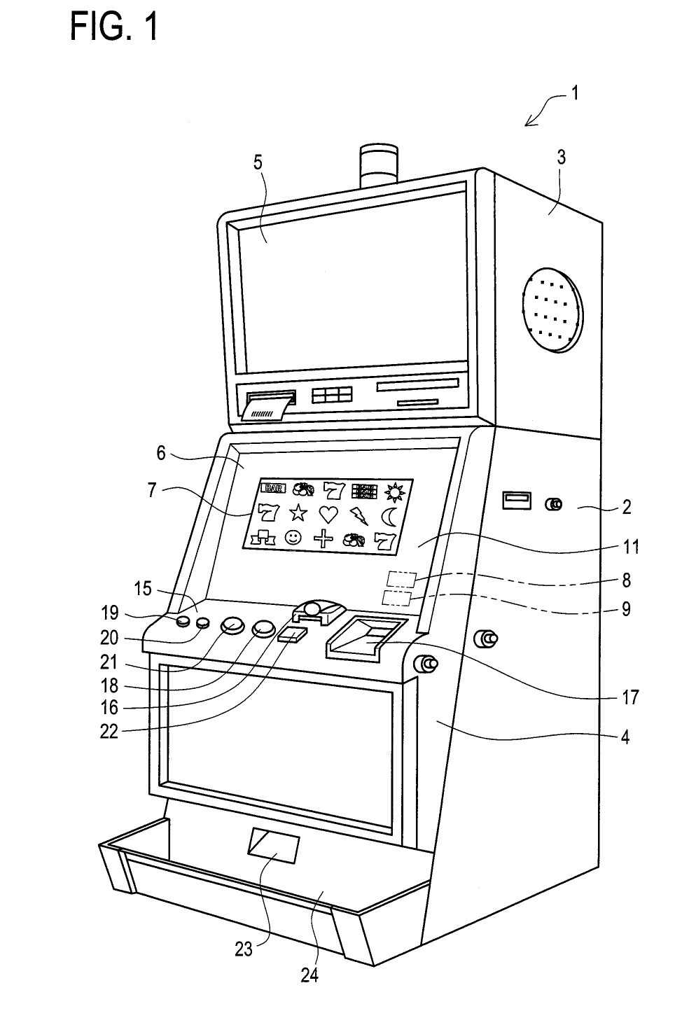

At first, a construction of a slot machine of the first embodiment embodying one or more aspects of the invention will be described with reference to FIG. 1. FIG. 1 is a perspective view showing the slot machine 1 of the first embodiment. The slot machine 1 may include a cabinet 2, a top box 3, and a main door 4. The top box 3 may be arranged on the cabinet 2 (for instance, arranged on upper side). The main door 4 may be arranged at front of the cabinet 2.

An upper display 5 is arranged with the slot machine 1 (for example, arranged in front of the top box 3). The upper display 5 may constructed from well-known liquid crystal display. Here, the upper display 5 may be CRTs, plasma displays, LED displays, OLED displays, and other known display technologies. Gaming information such as the methods for the game and a payout table may be displayed on the upper display 5.

A lower display 6 may be arranged on the main door 4. The lower display 6 may be constructed, for instance, from well-known liquid crystal display. Here, the lower image display 6 may be CRTs, plasma displays, LED displays, OLED displays, and other known display technologies. A symbol display portion 7 may be displayed on the lower display 6. Here, in some aspects, the upper display 5 and the lower display 6 may be combined into a single display or further separated into three or more displays. Here, predetermined number of symbols (for example, fifteen symbols) may be displayed on the symbol display portion 7 in accordance with the gaming sessions, and predetermined payout number will be provided based on the kind of the displayed symbols. A touch panel 11 may be arranged at the front of the lower display 6, and the player can input various instructions by operating the touch panel 11. Here, the number of displayed symbols is variable.

A credit count display portion 8 and a payout number display portion 9 may be arranged on the lower display 6. The credit count in which the player currently owns may be displayed on the credit count display portion 8. The payout number, which indicates the payout number which will be provided when a combination of stopped and displayed symbols on the symbol display portion 7 is any predetermined combinations, may be displayed on the payout number display portion 9.

A control panel 15 may be arranged at the lower display 6 (for example, arranged on lower side). Buttons may be arranged at the control panel 15. The buttons may be the buttons to input the instructions for gaming session by the player. A coin insertion slot 16 and a bill insertion portion 17 can be arranged in relation to the lower display 6 (for example, arranged on lower side). The coin insertion slot 16 may receive the gaming medium into the cabinet 2. A start button 18, a change button 19, a cash out button 20, a 1-bet button 21, and a max-bet button 22 may be arranged on the control panel 15. The start button 18 can be used when the instruction for the start for displaying the symbols is input. The change button 19 is used when the exchange is required. The cash out button 20 is the instruction for the payment of the coin (for example, one credit is equal to one coin) or for the print a ticket. One or more bar codes may be printed in the ticket. The ticket may be called GAMING VOUCHER. The coin may be paid through a coin payout opening 23 to a coin tray 24. Here, other than bar code may be used as substitute for the bar code (for example, QR Code (two-dimensional bar code)). The 1-bet button 21 is used when the instruction for the bet to one credit from the player's credits. The max-bet button 22 is used when the instruction for the bet to available maximum bet count in one game (for example, fifty credits) from the credits which is owned by the player is input. Here, 3-bet button or the like may or may not be arranged.

In the slot machine 1 of the first embodiment, the gaming medium may be coin, bill, or electronic value (credit). Here, the gaming medium may be other things as well (including but not limited to medal, token, electronic money, or ticket).

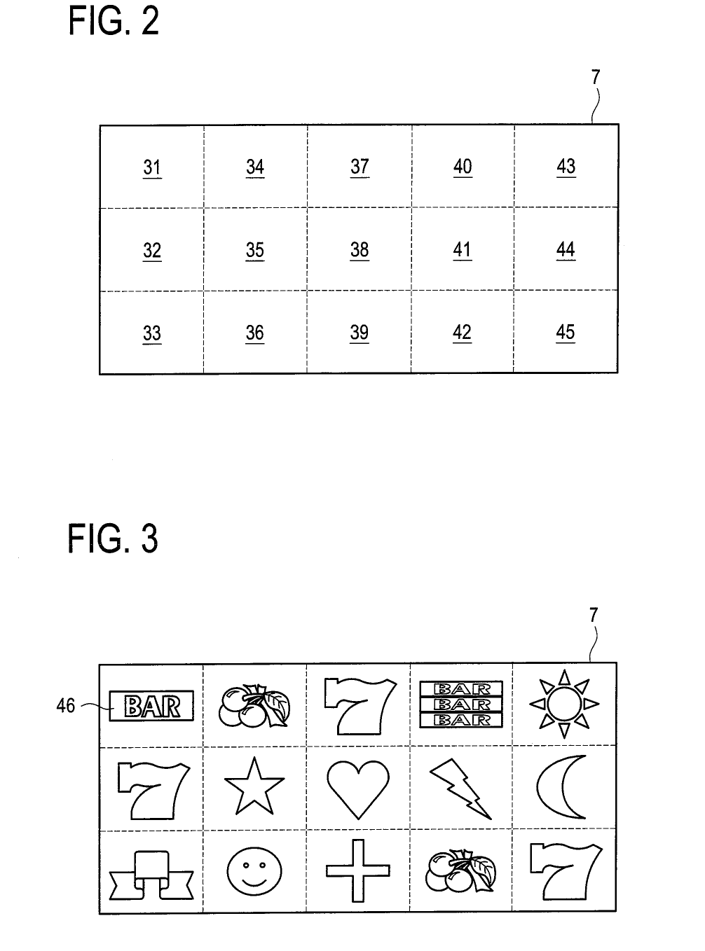

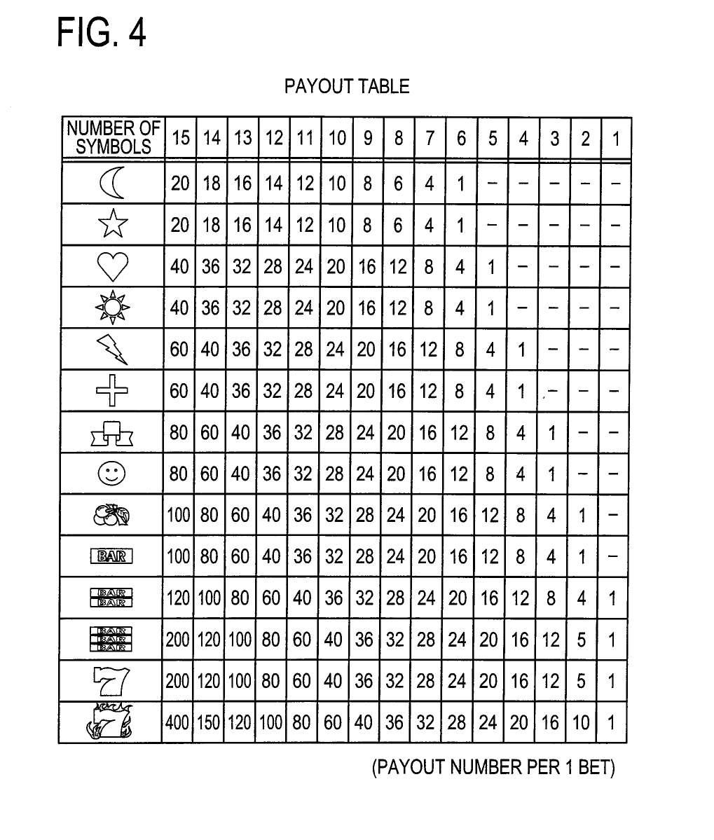

The symbols to be displayed on the symbol display portion 7 of the lower display 6 during the gaming session will be described with reference to FIG. 2 to FIG. 4. FIG. 2 shows the symbol display portion 7 of the first embodiment. FIG. 3 shows an example in which symbols 46 displayed on the symbol display portion 7. FIG. 4 shows a payout table indicating the payout number to be provided based on the symbols 46 displayed on the symbols display portion 7.

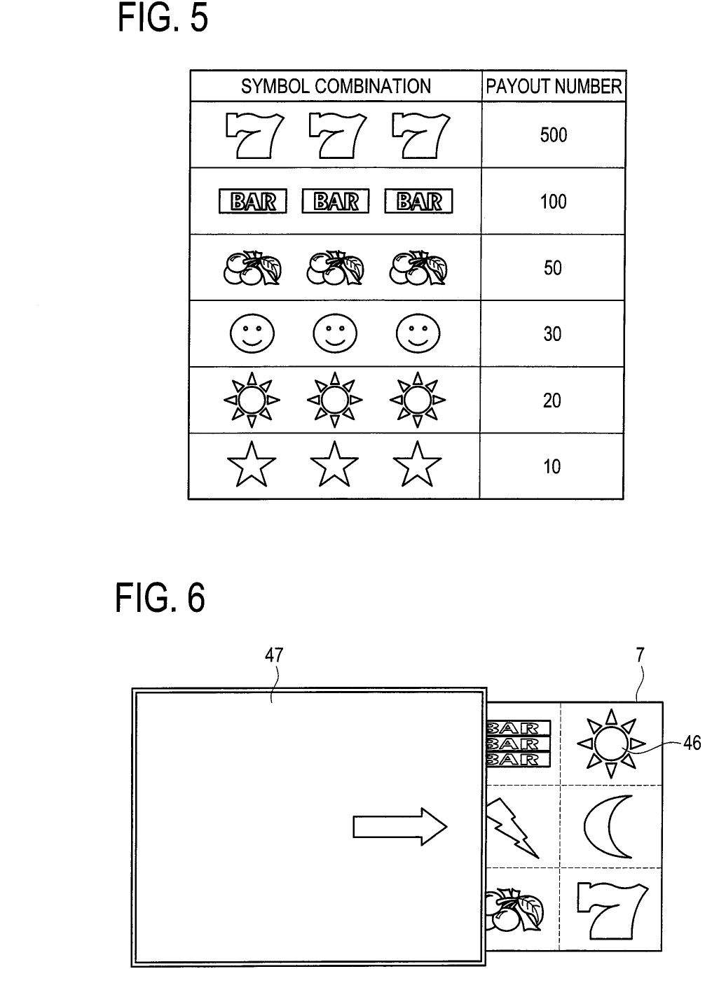

As shown in FIG. 2, the symbol display portion 7 of the first embodiment may be constructed from fifteen symbol display areas 31 to 45. Here, the number of the display areas is variable. When the game is started, each symbol 46 (for example, fifteen symbols) is displayed on each of the symbol display areas 31 to 45 respectively. Here, as shown in FIG. 3, the borders of each symbol display area 31 to 45 have dot leader to divide each of the symbol display areas 31 to 45, however, the dot leader may not be displayed in one or more aspects of the invention. In the slot machine 1 of the first embodiment, the game will be executed with the use of the symbols 46 as shown in FIG. 4. Here, the symbols 46 may include fourteen kinds of symbols and blank (BLANK SYMBOL). If the number of the same symbols displayed on the symbol display areas 31 to 45 is greater or equal to predetermined number, the game will be won regardless of the alignment of the symbols, and then, the payout number corresponding to the kind of the symbol and the number of the symbols. For example, if four “CHERRY” symbols 46 are displayed, payout number “8” will be provided. Here, FIG. 4 shows the payout number in case where the bet count is “1”. Accordingly, if the bet number is “1”, the payout number shown in FIG. 4 will be provided (or added to the credit count). If the bet count is more than “1”, the payout number in which the payout number shown in FIG. 4 is multiplied by the bet count will be provided (or added to the credit count). Here, in the first embodiment, if the number of same displayed symbols is greater or equal to the predetermined number shown in FIG. 4, the game is won and the payout number is provided, however, it may or may not be constructed that if one “7” symbol and three “CHERRY” symbols are displayed, the game is won and the payout will be provided. Also, it may or may not be constructed that payline is set on the symbol display areas 31 to 45 and the combination of the symbols displayed on the payout line is any of predetermined combinations, the payout will be provided. Further, the payout may or may not be provided based on the payout table shown in both FIG. 4 and FIG. 5. Here, as shown in FIG. 4, the winning combination may include one winning symbol (for example, if one “7” symbols is displayed, payout number “1” will be provided to the player.).

The game process in the slot machine 1 of the first embodiment will be described. When the bet operation is conducted and then the start button 18 is pressed, internal lottery process will be executed. The symbols to be displayed are determined in the internal lottery process. When predetermined time is elapsed since the start button 18 is pressed, fifteen symbols 46 are displayed on the symbol display areas 31 to 45 at once. Payout information corresponding to displayed symbols 46 (see FIG. 4) is displayed. After the payout is provided to the player, displayed symbols 46 are erased at once. Here, displayed symbols 46 may be erased with the use of a curtain image 47. For example, as shown in FIG. 6, the curtain image 47 is displayed gradually from predetermined direction (for example, from left). Also, at first, the symbol not corresponding to winning combination may be erased at once, and then the symbol corresponding to winning combination may be erased. Further, the symbol may lighten gradually to be erased. The symbol may be moved to outside the screen of the window of the display to be erased. Here, the method for erasing displayed symbols is variable.

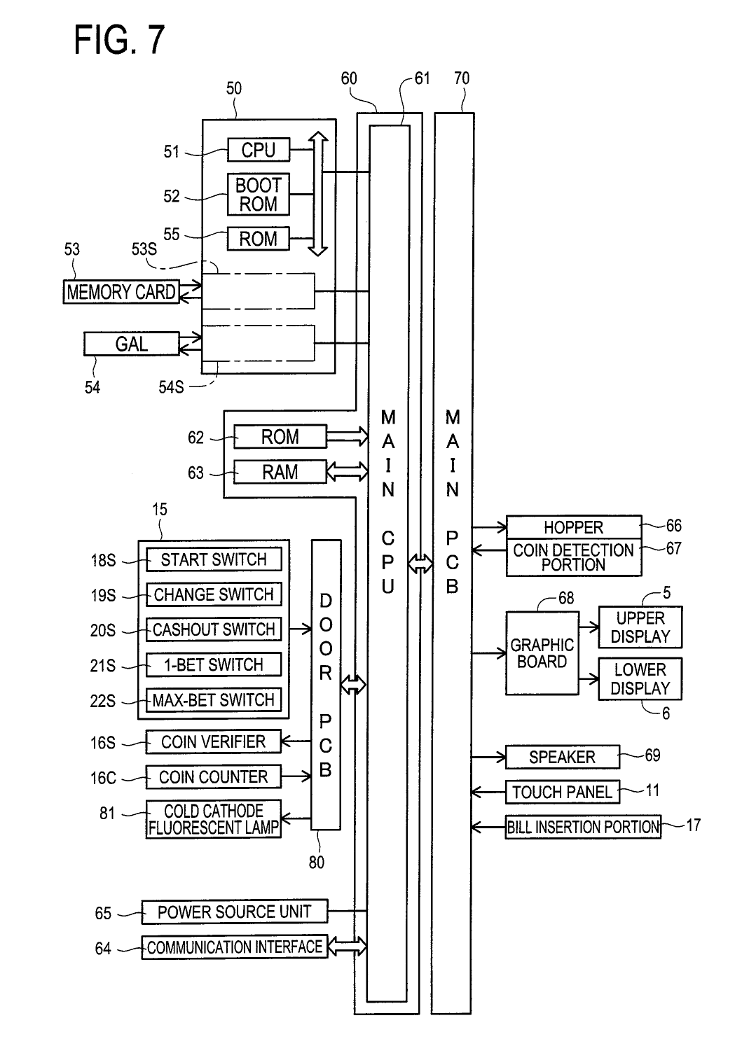

A control system of the first embodiment of the slot machine 1 will be described with reference to FIG. 7. FIG. 7 is block diagram schematically showing the control system of the slot machine 1 of the first example.

The control system of the slot machine 1 may be constructed from a mother board 60 and a gaming board 50 as shown in FIG. 7. The gaming board 50 may be constructed from a CPU 51, a ROM 55, a boot ROM 52, a card slot 53S, and an IC socket 54S. The CPU 51, the ROM 55, and the boot ROM 52 are interconnected via internal bus. A card slot 53S is adapted to receive the memory card 53. An IC socket 54S is adapted to receive a GAL (Generic Array Logic) 54. Here, PLD (Programmable Logic Device) which is other than the GAL 54 may be substituted for the GAL 54.

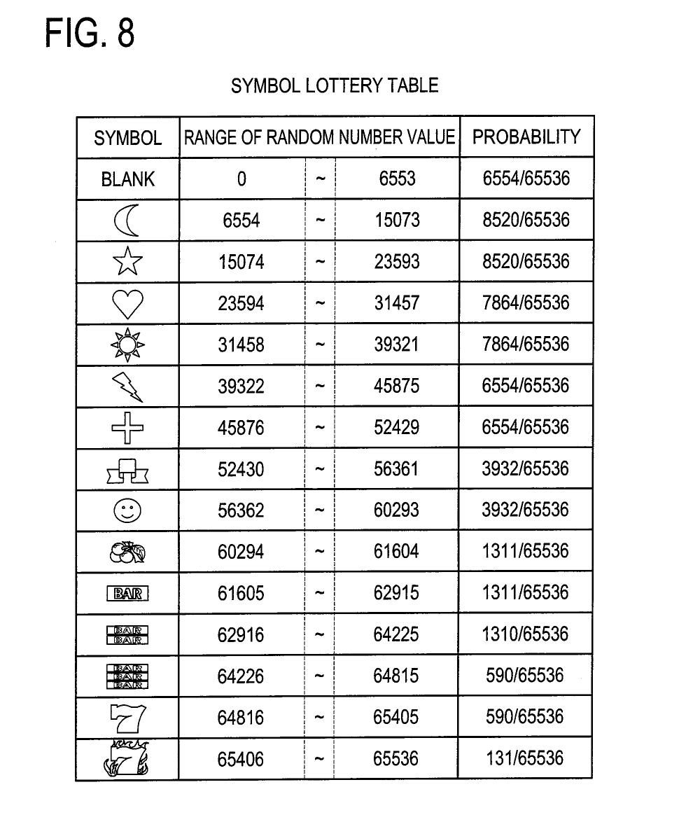

The memory card 53 may be constructed from non-volatile memory. A game program and a game system program (hereinafter, “the game program and the like”) is stored therein. The game program stored in the memory card 53 may include a lottery program. The lottery program is used to determine the symbols 46 to be displayed on the symbols display areas 31 to 45. The symbol lottery table is stored in the memory card 53. The symbols lottery table is used to conduct the lottery of the symbols 46 to be displayed in the symbols display areas 31 to 45. FIG. 8 shows the symbol lottery table used in the slot machine of the first embodiment.

As shown in FIG. 8, the symbol lottery table indicates the relation between each of the symbols (including BLANK SYMBOL) and one or more random number values which lie in predetermined range (for example, “0” to “65536”). That is, each symbol corresponds to plural random number values. The random number value is determined by lottery, and the symbol corresponding to the random number value will be stopped. Concretely, in the slot machine 1 of the first embodiment, fifteen random number values may be determined without overlapping. Fifteen symbols are determined based on the determined random number values. The determined symbols are displayed on each of the symbol display areas 31 to 45. If sampled random number value is any of previous sampled random number values, a random number value is sampled again. Accordingly, it allows that each sampled random number value is not overlapped each other.

Each of fifteen symbols may or may not be determined with the use of different lottery table respectively. For example, at first, first symbol is determined with the use of the symbol lottery table shown in FIG. 8 (hereinafter “first symbol lottery table”). Next, the symbol is determined with the use of a second symbol lottery table. With respect to the second symbol lottery table, “1” is subtracted from the range of the random number value, in which the first symbol belongs thereto. Further, third symbol is determined with the use of third symbol lottery table. With respect to the third symbol lottery table, “1” is subtracted from the ranges of the random number values, in which the first symbol and the second symbol belong thereto. Similarly, the rest of the symbols (fourth symbol to fourteenth symbol) are determined.

The mother board 60 will be described. The mother board 60 may be constructed from general mother board (printed circuit board which mounts basic components of personal computer), and may include a main CPU 61, a ROM 62, a RAM 63, and a communication interface 64.

The ROM 62 may be constructed from a memory device such as the flash memory (for example). The preliminary data such as BIOS program may be stored in the ROM 62. BIOS program can be executed by the main CPU 61. If the BIOS is executed by the main CPU 61, the initial process for predetermined peripheral devices, and the read process for the game program and the like stored in the memory card 53 will be started via the gaming board 50.

The data and the programs, which are used when the main CPU 61 runs, may be stored in the RAM 63. The verification program (which will be read via the gaming board 50), various programs (such as the game program and the like), the number of the player's credits, and the number of executed games may be stored in the RAM 63.

The communication interface 64 may be a communication device communicating to the server located in the game hall via a communication line or other communication pathway.

A main PCB (Printed Circuit Board) 70 and a door PCB 80 (which will be described later) are connected to the mother board 60 respectively via USB (for example). A power source unit 65 is connected to the mother board 60. If the power source unit 65 supplies the electric power to the mother board 60, the main CPU 61 on the mother board 60 will be booted up. When the electric power is supplied to the gaming board 50, the CPU 51 will be booted up.

The hopper 66, a coin detection portion 67, a graphic board 68, the loud speaker 68, a touch panel 11, a bill insertion portion 17, and the like may be connected directly or indirectly to the main PCB 70.

The graphic board 68 controls the display image on the upper display 5 and the lower display 6 based on the control signal from the main CPU 61. For example, symbols 46 on the symbol display portion 7 are displayed and erased by the graphic board 68 during the game session.

A control panel 15, the coin verifier 16S, and the coin counter 16C are directly or indirectly connected to the door PCB 80. Here, a cold cathode fluorescent lamp 81 may be connected to the door PCB 80. A start switch 18S, a change switch 19S, a cash-out switch 20S, a 1-bet switch 21S, and a max-bet switch 22S are arranged on the control panel 15. The start switch 18S is associated with the start button 18. The change switch 19S is associated with the change button 19. The cash-out switch 20S is associated with the cash-out button 20. The 1-bet switch 21S is associated with the 1-bet button 21. The max-bet switch 22S is associated with the max-bet button 22. Each of switches may output the input signal to the main CPU 61 when the button corresponding thereof is operated by the player. Here, a 3-bet switch and 5-bet switch may be arranged.

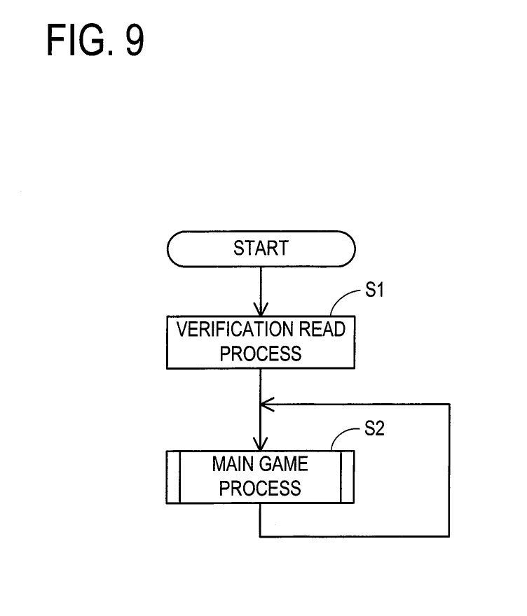

A main control program, which is executed in the slot machine 1 of the first embodiment, will be described in detail with reference to the drawing. FIG. 9 is a flowchart of the main control program. Concerning the slot machine 1, the memory card 53 is connected to the card slot 53S of the gaming board 50, and the GAL 54 is connected to the IC socket 54S beforehand.

When the power switch of the power source unit 65 is ON, the mother board 60 and the gaming board 50 are booted-up respectively, and the verification read process (S1) is executed. In the verification read process, the mother board 60 and the gaming board 50 execute separate processes in parallel. In the gaming board 60, the CPU 51 reads the preliminary verification program from the boot ROM 52, and verifies that the verification program is not falsified before the verification program is taken to the mother board 60. In the mother board 60, the main CPU 61 executes BIOS stored in the ROM 62, and checks and initializes various peripheral devices. Here, BIOS may be compressed, then, BIOS is decompressed. BIOS may be copied to the RAM 63.

The main CPU 61 reads the verification program stored in the ROM 55, and verifies that game program and the like is not falsified. Here, the game program and the like is stored in the memory card 53 which is inserted to the card slot 53S. After the verification process is ended, the main CPU 61 writes the verified game program and the like to the RAM 43. Also, the main CPU 61 acquires payout ratio setting data from the GAL 54 via the gaming board 50, and write the payout ratio setting data to the RAM 63. After the process mentioned above is finished, the main CPU 61 finishes the verification read process.

In S2, the main CPU 61 reads the game program and the like verified in S1 from the RAM 63, and executes the main game process. The game in the first embodiment of the slot machine 1 is executed by executing the main game process. The main game process is executed repeatedly while the electronic power source is supplied.

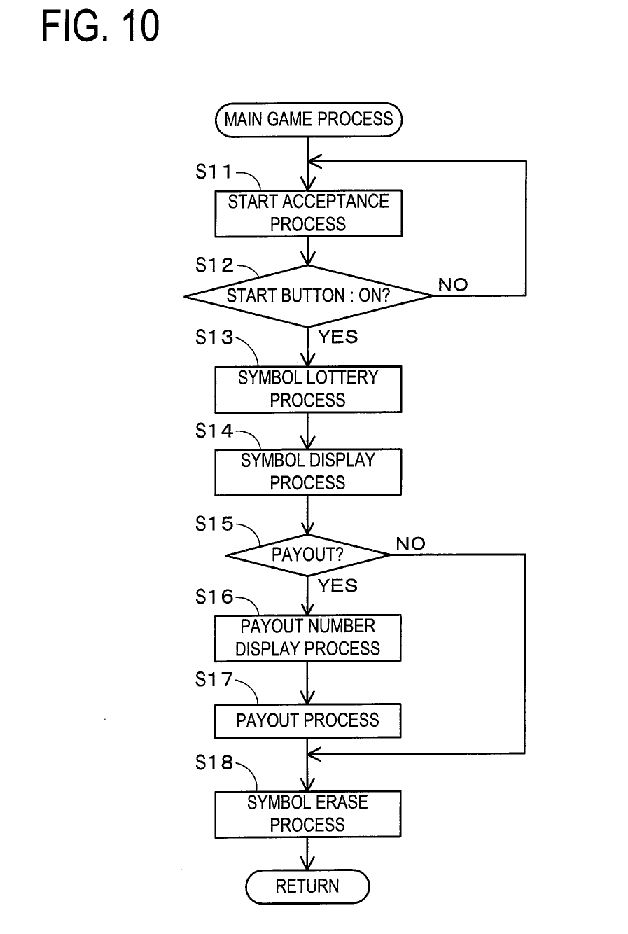

A sub process of the main game process in S3 will be described with reference to FIG. 10. FIG. 10 is a flowchart of the main game process in the first embodiment of the slot machine 1. Here, each of the programs shown in the flowcharts in FIG. 10 is stored in the memory card 53. The programs are decompressed to the RAM 63 of the slot machine 1, and decompressed programs are executed by the main CPU 61.

In S11, the main CPU 61 performs predetermined initial setting, and then, executes the start acceptance process as shown in FIG. 10. In the initial setting process, some data set in predetermined data areas (for example, payout counter) is cleared. In the start acceptance process, the coin is inserted by the player, or the bet operation with the use of the 1-bet button 16 or max-bet button 17 is operated by the player during the start acceptance process. Here, 3-bet button and/or 5-bet button may or may not be operated.

In S12, the main CPU 61 determines whether or not the start button 18 is operated. It is determined whether or not the spin button 18 is operated based on that whether or not the input signal is received. If the start button 18 is not operated (S12:NO), the procedure will be returned to the start acceptance process (S11) again. In that time, some instructions such as to change the bet count are available. On the other hand, if the start button 18 is operated (S12:YES), the bet count, which is set based on the operation of 1-bet button 21 or max-bet button 22, will be subtract from credit count in which the player owns. And, the bet count will be stored in RAM 63 as the bet information.

In S13, the symbol lottery process is executed. In the symbol lottery process, the symbols, which will be displayed on each of the symbol display areas 31 to 45 of the symbol display portion 7, will be displayed by the main CPU 61. Concretely, the main CPU 61 determines fifteen random number values among predetermined range of the random number values (for example, “0” to “65536”) which correspond to each of the symbol display areas 31 to 45 without overlapping by executing the random number generation program included in the lottery program stored in the RAM 63. The fifteen symbols 46 to be displayed on each of the symbol display areas 31 to 45 are determined among plural symbols based on fifteen selected random number values with the use of the symbol lottery table (FIG. 8).

In S14, the main CPU 61 displays fifteen symbols 46 selected in S13 on the symbol display areas 31 to 45 of the symbol display portion 7 at once (see FIG. 3).

In S15, the CPU 61 determines whether or not the payout will be provided based on the combination of the symbols displayed on the symbol display areas 31 to 45. If it is determined that the payout will be provided (S15:YES), the procedure will be shifted to S16. On the other hand, it is determined that the payout will not be provided (S15:NO), the procedure will be shifted to S18. Here, if the combination of the symbols is any predetermined combination, the procedure will be shifted to a bonus game. The bonus game may or may not be free game. Here, the main CPU 61 determined whether or not the condition, where the procedure will be shifted to the bonus game after executed S15, is met. If it is determined that the procedure will be shifted to the bonus game, the free game will be executed predetermined times. The free game will be executed without the consuming credit. Here, the condition where the procedure will be shifted to the bonus game may or may not be that predetermined number of predetermined symbols are displayed. Also, the condition may be met unexpectedly as a mystery game. Here, the condition is variable. In the free game, another lottery table which is better than the base game for the player may or may not be used.

In S16, payout information corresponding realized winning combination may be displayed on the lower display 6. Accordingly, the payout information is informed to the player. Here, FIG. 11 to 13 shows the symbol display portion 7 in which the payout information is displayed thereon in S16 of the payout display process.

In the combination shown in FIG. 11, three “7” symbols 90, two “CHERRY” symbols 91, and one “3BAR” symbol are displayed. At first, as shown in FIG. 11, winning frame 93 may be displayed around the “7” symbols 90. Accordingly, the symbols 90 corresponding to winning combination are displayed emphatically. That is, the symbols are highlighted. And then, payout information 94 which indicates “12 CREDITS” of the payout corresponding to the winning combination of three “7” symbols will be displayed on nearly center of the symbol display portion 7 with overlapped. Here, the color of the symbol associated with the winning combination may be changed as to emphasis. Also, the symbols associated with the winning combination may blink so as to emphasis. Here, the payout information may or may not be displayed outside the symbol display portion 7.

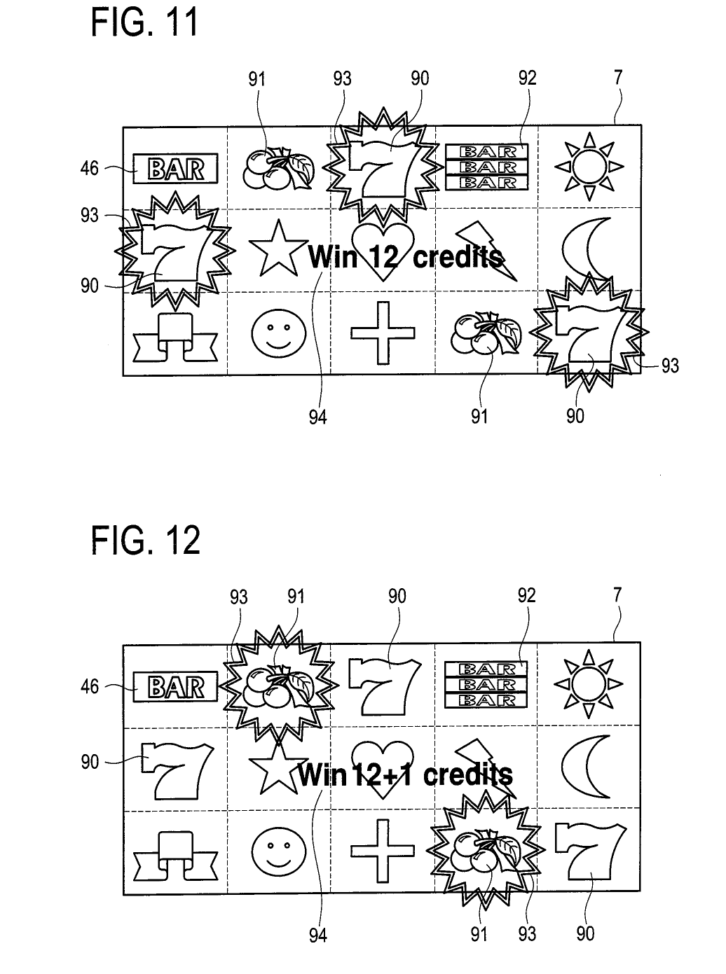

As shown in FIG. 12, the winning frame 93 may be displayed around the “CHERRY” symbols 91 shown in FIG. 12. Accordingly, the symbol 91 corresponding to the winning combination may be displayed emphatically. That is, the symbols are highlighted. The payout information 94 which indicates the payout “1 CREDIT” corresponding to the winning combination of two “CHERRY” symbols will be displayed on nearly center of the symbol display portion 7 with overlapped. Here, the payout information 94 may be displayed as accumulated payout number in which the payout number for the winning combination of three “7” symbols is accumulated (namely, “13 CREDITS”). Further, after the payout information “12 CREDITS” is displayed, the payout information “1 CREDIT” (corresponding to the winning combination of two “CHRYY” symbols) may be displayed.

As shown in FIG. 13, winning frame 93 may be displayed around the “3BAR” symbol 91. Accordingly, the symbol 92 corresponding to winning combination are displayed emphatically. That is, the symbols are highlighted. The payout information 94 which indicates the payout “1 CREDIT” corresponding to the winning combination of one “3BAR” symbol may be displayed on nearly center of the symbol display portion 7 with overlapped.

In S17, the main CPU 61 provides the payout corresponding to the combination of the displayed symbols (see FIG. 4) to the player. Here, if the player presses the cashout button 20, the coins in which the number of the coins corresponds to the credit count (for example, 1 credit count corresponds to 1 coin) may be provided. Also, the ticket with barcode 25 may or may not be provided.

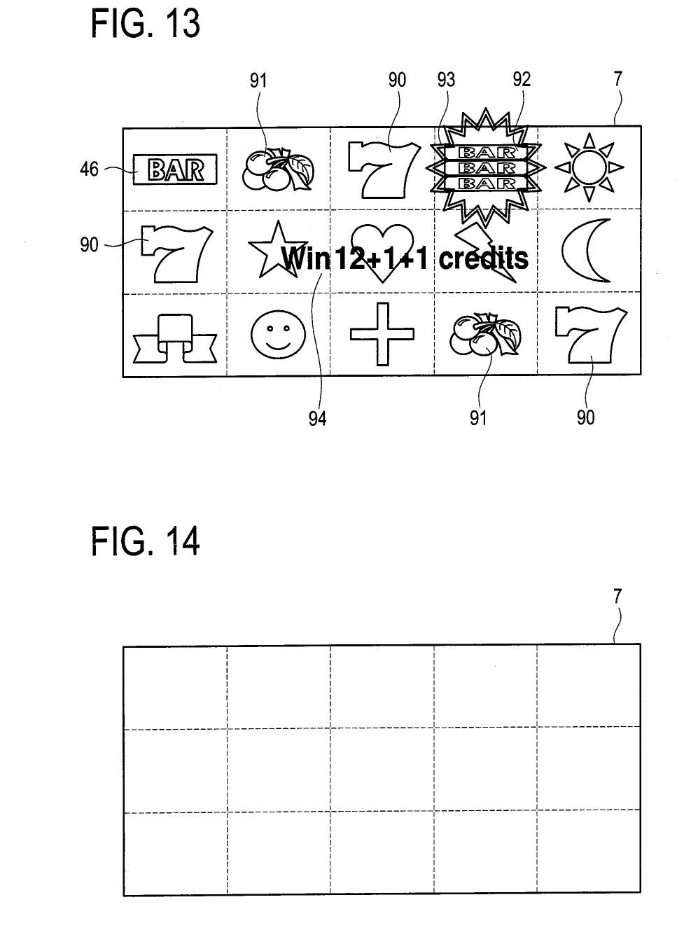

In S18, all symbols displayed on each of the symbol display areas 31 to 45 of the symbol display portion 7 at once. At result, as shown in FIG. 14, the symbol display portion 7 will be displayed without symbols. And, when next game is started, new symbols may be displayed. Here, after all symbols are erased, various information may or may not be displayed on the lower display 6. The various information may or may not include background image, demo image, enlarged image of the game result or current credit count, image of the game rule, image of bonus game content, image of game advertisement, or the like.

As mentioned above, in the slot machine 1 of the first embodiment, when bet operation is conducted and then the game is started, fifteen symbols to be displayed on the symbol display portions of the symbol display portion 7 are determined with the use of the random number values and symbols lottery table by lottery (S13), and determined fifteen symbols are displayed on the symbol display areas 31 to 45 of the low display 6 without mechanical reels. Accordingly, one or more aspects of the invention allow conducting various production or demonstration on above method.

### Second Embodiment

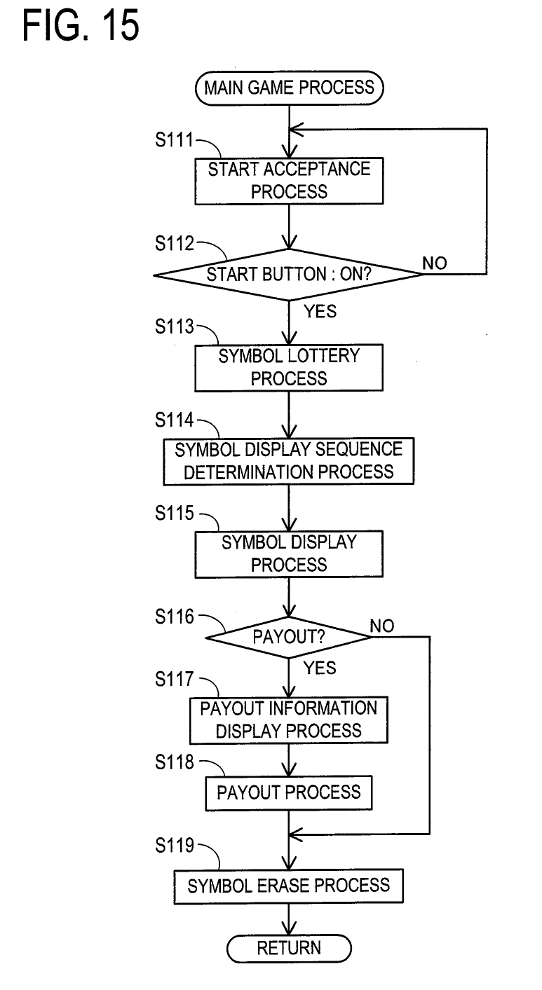

Next, a slot machine of the second embodiment embodying one or more aspects of the invention will be described with reference to FIG. 15 to 18. The reference characters of FIG. 15 to 18, which are the same as the reference characters of FIGS. 1 to 14, designate the same parts thereof.

A structure of the slot machine of the second embodiment is almost same as in the first embodiment of the slot machine. A control process of the slot machine in the second embodiment is almost same as the slot machine of the first embodiment. Here, in the slot machine 1 of the first embodiment, determined fifteen symbols corresponding to the symbol display areas 31 to 45 of the symbol display portion 7 are displayed at once, on the other hand, in the slot machine of the second embodiment, determined fifteen symbols are displayed in random order (random sequence).

The sub process of the main game process in the slot machine of the second embodiment will be described with reference to FIG. 15. FIG. 15 is a flowchart of the main game process program in the slot machine of the second embodiment.

The processes of S111 to S113 are the same as the processes as S11 to S13 (in the main game process of the first embodiment above mentioned), so this explanation will be omitted. In S114, the main CPU 61 determines display sequence of the symbol display areas 31 to 45 of the symbol display portion 7. For example, it is determined that the display sequence is the symbol display area “31” (first)→the symbol display area “40” (second)→the symbol display area “35” (third)→the symbol display area “33” (fourth)→ . . . . That is, at first, the symbol corresponding to the symbol display area “31” will be displayed. Second, the symbol corresponding to the symbol display area “40” will be displayed. Third, the symbol corresponding to the symbol display area “35” will be displayed. Fourth, the symbol corresponding to the symbol display area “33” will be displayed. Here, the display sequence may be the sequence in the case where each one symbol is displayed. Also, determined displayed sequence may be the sequence in the case where each of two symbols is displayed at once. That is, for example, at first, the symbol corresponding to the symbol display area “35” and “38” may be displayed at once. Second, the symbol corresponding to the symbol display area “31” and “36” may be displayed at once. Further, determined display sequence may be the sequence in the case where each of three symbols is displayed at once. The display sequence is changed every game. Accordingly, the display sequence determined randomly.

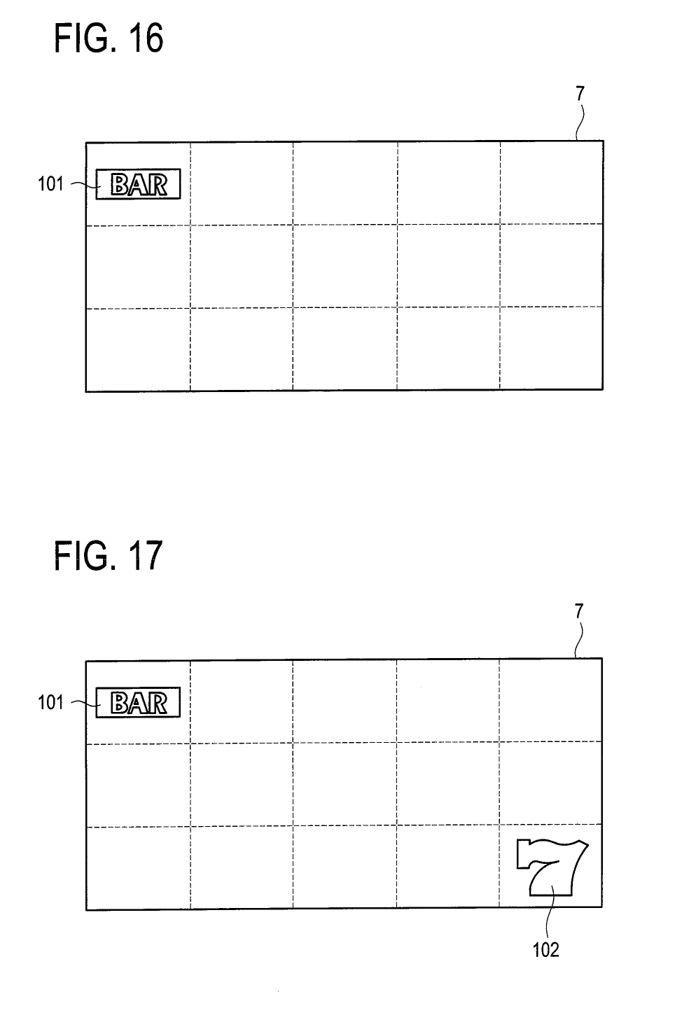

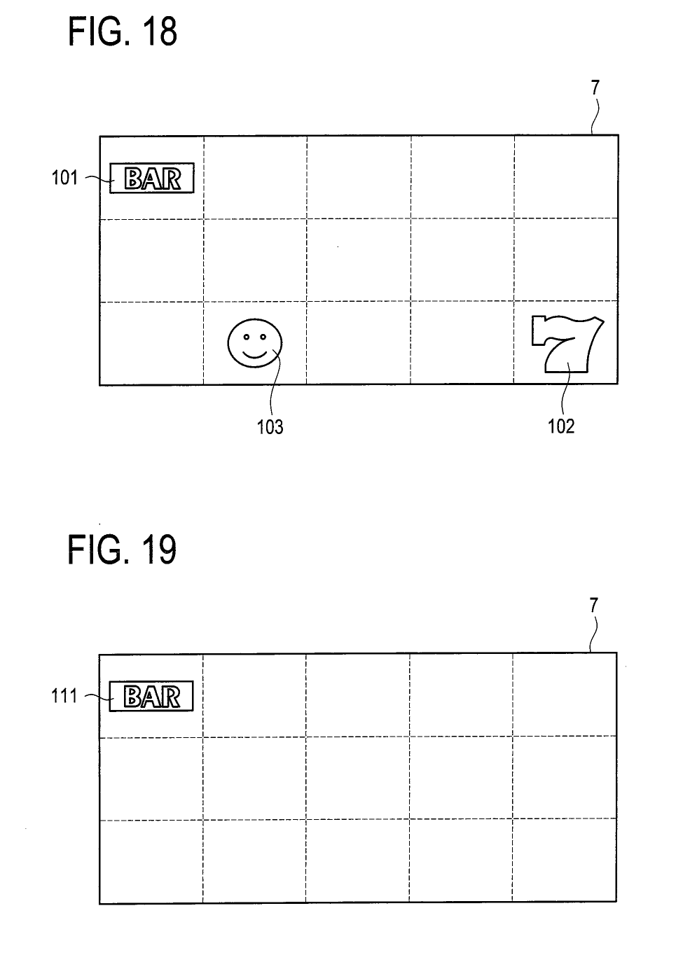

In S115, the main CPU 61 displays fifteen symbols 46 on the symbol display portion 7 in the predetermined order determined in S114. FIGS. 16 to 18 show an example of the display sequence in S115. At first, as shown in FIG. 16, the “BAR” symbol 101 is displayed on the symbol display area 31. Next, as shown in FIG. 17, the “7” symbol 102 is displayed on the symbol display area 36. Next, as shown in FIG. 18, the “FACE” symbol 103 is displayed on the symbol display area 36. Similarly, the symbols are displayed on the rest of the symbol display area 31 to 45.

In S116, the main CPU 61 determined whether or not the payout will be provided based on the combination of the symbols displayed on the symbol display areas 31 to 45. If it is determined that the payout will be provided (S116:YES), the procedure will be shifted to S117. On the other hand, if it is determined that the payout will not be provided (S116:NO), the procedure will be shifted to S119.

In S117, the payout information corresponding to realized winning combination may be displayed on the lower display 6. Accordingly, the payout information is informed to the player. Here, the payout information will be displayed after all symbols are displayed. Also, the payout information will be displayed when the symbols corresponding to winning combination is displayed.

In S118, the main CPU 61 provided the payout corresponding to the combination of the displayed symbols (see FIG. 4) to the player. Here, if the player presses the cashout button 20, the coins in which the number of the coins corresponds to the credit count (for example, 1 credit count corresponds to 1 coin) may be provided. Also, the ticket with barcode 25 may or may not be provided.

In S119, all symbols displayed on each of the symbol display areas 31 to 45 of the symbol display portion 7 at once. At result, as shown in FIG. 14, the symbol display portion 7 is displayed without symbols. And, when next game is started, new symbols may be displayed.

As mentioned above, in the slot machine 1 of the second embodiment, when bet operation is conducted and then the game is started, fifteen symbols to be displayed on the symbol display portions of the symbol display portion 7 are determined with the use of the random number values and symbols lottery table by lottery (S113), and the display sequence for symbols corresponding to the symbol display areas 31 to 45 is determined by lottery (S114). And then, determined fifteen symbols are displayed on the symbol display areas 31 to 45 of the low display 6 in the determined random order (S115) without mechanical reels. Accordingly, one or more aspects of the invention allow conducting various production or demonstration on above method. Here, the display sequence for the symbols is changed every the game, so the sequence for the symbols is irregularity.

### Third Embodiment

Next, a slot machine of the third embodiment embodying one or more aspects of the invention will be described with reference to FIGS. 19 to 22. The reference characters of FIGS. 19 to 22, which are the same as the reference characters of FIGS. 1 to 14, designate the same parts thereof.

A structure of the slot machine of the third embodiment is almost same as in the first embodiment of the slot machine. A control process of the slot machine in the third embodiment is almost same as the slot machine of the first embodiment. Here, in the slot machine 1 of the first embodiment, determined fifteen symbols corresponding to the symbol display areas 31 to 45 of the symbol display portion 7 are displayed at once, on the other hand, in the slot machine of the third embodiment, determined fifteen symbols are displayed in accordance with the predetermined order (in regular order).

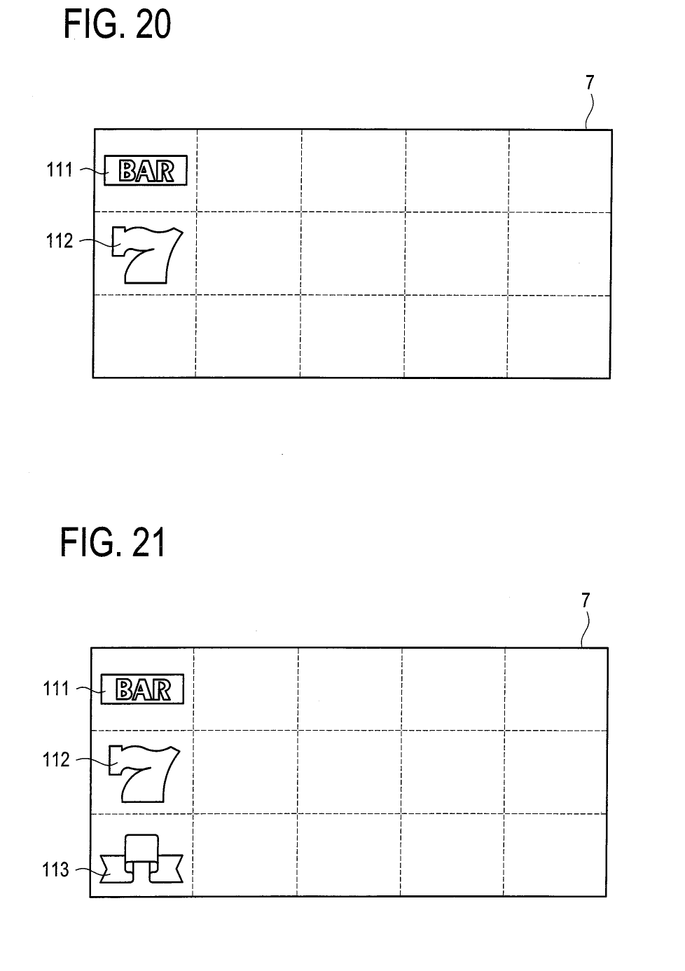

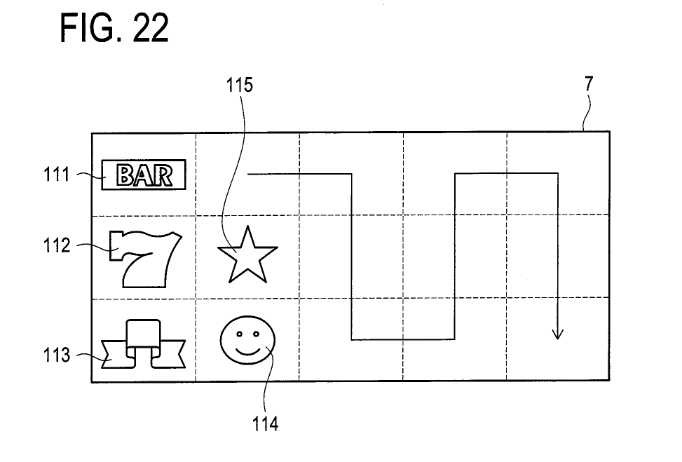

FIG. 19 to FIG. 21 shows an example of the display sequence of fifteen symbols to be displayed on the symbol display areas 31 to 45 of the symbol display portion 7 determined in S13. At first, as shown in FIG. 19, the “BAR” symbol 111 is displayed on the symbol display area 31. Next, as shown in FIG. 20, the “7” symbol 112 is displayed on the symbol display area 32. Next, as shown in FIG. 21, the “RIBBON” symbol 113 is displayed on the symbol display area 33. Similarly, the rest of the symbols (for example, the symbol 114, the symbol 115, or the like) are displayed on the rest of the symbol display area 31 to 45 in regular order (which is up and down) shown in FIG. 22. Here, the display sequence is variable (for example, including but not limited left and right, spirally, or the like). Also, plural display sequences are set, and one display sequence may be selected among plural display sequences randomly.

As mentioned above, in the slot machine 1 of the third embodiment, when bet operation is conducted and then the game is started, fifteen symbols to be display on the symbol display areas 31 to 45 of the symbol display portion 7 are determined with the use of the random number values and symbols lottery table by lottery. And then, determined fifteen symbols are displayed on the symbol display areas 31 to 45 of the low display 6 in accordance with the predetermined order (in predetermined order) without reels. Accordingly, one or more aspects of the invention allow conducting various production or demonstration on above method.

Here, aspects of the present invention are not limited to the above embodiment and various changes and modification can be done within the scope of the present invention. For example, in the first embodiment to the third embodiment, the fifteen symbols form a 5 (wild)×3 (height) rectangular grid. However, the invention is not so limited. For example, the alignment of the fifteen symbols is variable as long as all symbols are displayed on the lower display 6. Further, when winning combination is realized, the payout information thereof may be informed by the loudspeaker with sound.

In the first embodiment to the third embodiment, each symbol is displayed with same size regardless of the kind of the symbols. However, the invention is not so limited. For example, the size of the symbols may or may not be different each other. Each of the first embodiment to the third embodiment may be conjunction with each other. For example, each of half portions of the symbols is displayed at once, and then the rest of portions may be displayed in random order. Further, aspects of the present invention will be used in the bonus game of the video reel slot machine. Further, one or more aspects of the present may be used video type card game such as porker game.

Although the subject matter has been described in language specific to structural features and/or methodological acts, it is to be understood that the subject matter defined in the appended claims is not necessarily limited to the specific features or acts described above. Rather, the specific features and acts described above are disclosed as example forms of implementing the claims.

What is claimed is:

1. A gaming machine comprising:
a display device having a plurality of display areas, and
a processor programmed to:
(a) select symbols among a plurality of different kinds of symbols after a game is started, each of the selected symbols being associated with the display area, the associated display areas being different each other,
(b) display the selected symbols in each of the display areas at once, and
(c) provide an award to a player in response to a combination of the displayed symbols being a winning combination.

2. A gaming machine comprising:
a display device having a plurality of display areas, and
a processor programmed to:
(a) select symbols among a plurality of different kinds of symbols after a game is started, each of the selected symbols being associated with the display area, the associated display areas being different each other,
(b) display the selected symbols in each of the display areas in random order, and
(c) provide an award to a player in response to a combination of the displayed symbols being a winning combination.

3. A gaming machine comprising:
a display device having a plurality of display areas, and
a processor programmed to:
(a) select symbols among a plurality of different kinds of symbols after a game is started, each of the selected symbols being associated with the display area, the associated display areas being different each other,
(b) display the selected symbols in each of the display areas in a first predetermined order, and
(c) provide an award to a player in response to a combination of the displayed symbols being a winning combination.

4. The gaming machine according to claim 3, wherein the first predetermined order is changed every a unit game.

5. The gaming machine according to claim 1 wherein the processor is programmed to erase the displayed symbols.

6. The gaming machine according to claim 2 wherein the processor is programmed to erase the displayed symbols.

7. The gaming machine according to claim 3 wherein the processor is programmed to erase the displayed symbols.

8. The gaming machine according to claim 1, wherein the processor is programmed to erase the displayed symbols in a second predetermined order.

9. The gaming machine according to claim 2, wherein the processor is programmed to erase the displayed symbols in a second predetermined order.

10. The gaming machine according to claim 3, wherein the processor is programmed to erase the displayed symbols in a second predetermined order.

11. The gaming machine according to claim 1, wherein the processor is programmed to display symbols emphatically in response to the winning combination being realized, the emphasized symbols being associate with the winning combination.

12. The gaming machine according to claim 2, wherein the processor is programmed to display symbols emphatically in response to the winning combination being realized, the emphasized symbols being associate with the winning combination.

13. The gaming machine according to claim 3, wherein the processor is programmed to display symbols emphatically in response to the winning combination being realized, the emphasized symbols being associate with the winning combination.

14. The gaming machine according to claim 1, wherein the processor is programmed to inform award information of the award, the award being provided to the player.

15. The gaming machine according to claim 2, wherein the processor is programmed to inform award information of the award, the award being provided to the player.

16. The gaming machine according to claim 3, wherein the processor is programmed to inform award information of the award, the award being provided to the player.

17. A gaming method comprising:
displaying a plurality of display areas,
selecting symbols among a plurality of different kinds of symbols after a game is started, each of the selected symbols being associated with the display area, the associated display areas being different each other,
displaying the selected symbols in each of the display areas at once, and
providing an award to a player in response to a combination of the displayed symbols being a winning combination.

18. A gaming method comprising:
displaying a plurality of display areas, and
selecting symbols among a plurality of different kinds of symbols after a game is started, each of the selected symbols being associated with the display area, the associated display areas being different each other,
displaying the selected symbols in each of the display areas in random order, and
providing an award to a player in response to a combination of the displayed symbols being a winning combination.

19. A gaming method comprising:
displaying a plurality of display areas,
selecting symbols among a plurality of different kinds of symbols after a game is started, each of the selected symbols being associated with the display area, the associated display areas being different each other,
displaying the selected symbols in each of the display areas in a first predetermined order, and
providing an award to a player in response to a combination of the displayed symbols being a winning combination.
